(19) United States
(12) Patent Application Publication
(10) Pub. No.: US 2005/0285497 A1
(43) Pub. Date: Dec. 29, 2005

(54) Electron-emitting device, electron source, image display apparatus, and television apparatus

(75) Inventor: Miki Tamura, Isehara-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/165,359

(22) Filed: Jun. 24, 2005

(30) Foreign Application Priority Data
Jun. 29, 2004 (JP) 2004-191634

(51) Int. Cl. H01J 1/00

(52) U.S. Cl. 313/310

(57) ABSTRACT

An electron-emitting device includes a first silicon oxide body containing halogen and a pair of electrically conductive films on the body.

### BACKGROUND OF THE INVENTION

1. Field of the Invention

The present invention relates to an electron-emitting device, an electron source, an image display apparatus, and a television apparatus for use in a television system, a computer display, and an electron beam lithography system.

2. Description of the Related Art

Electron-emitting devices include field emission type electron-emitting devices and surface-conduction electron-emitting devices.

Field emission type electron-emitting devices and surface-conduction electron-emitting devices include lateral-type electron-emitting devices having a pair of opposed electrically conductive films formed in opposition to each other on a substrate.

In the lateral-type electron-emitting devices, leakage current sometimes flows between the pair of electrically conductive films, depending on the applied voltage not only when the devices are operating, but also when they are not operating. The leakage current may be an electric current component flowing on the surface of the substrate between the pair of electrically conductive films, an electric current component flowing in the substrate between the pair of electrically conductive films, or an electric current component caused by slight contact between the pair of electrically conductive films.

Japanese Patent No. 03147267 discloses a method for providing a concave portion in a substrate between a pair of electrically conductive films to reduce the leakage current. Japanese Patent Laid-Open No. 2000-21300 discloses a method for adsorbing fluorine on the surface of a substrate before depositing a pair of electrically conductive films on the substrate to prevent contact between the pair of electrically conductive films.

### SUMMARY OF THE INVENTION

However, in the method for providing a concave portion in a substrate between a pair of electrically conductive films according to the Japanese Patent No. 03147267, the surface of the substrate between the pair of electrically conductive films is etched while the pair of electrically conductive films are used as a mask. This may damage the electrically conductive films.

On the other hand, in the method for adsorbing fluorine on the surface of a substrate according to the Japanese Patent Laid-Open No. 2000-21300, contact between a pair of electrically conductive films can be prevented and thereby the leakage current can be reduced. However, the effect of decreasing the leakage current flowing in the substrate is not large. Thus, further reduction in the leakage current is required.

Furthermore, although the details are unknown, when lateral-type electron-emitting devices are operated continuously, the leakage current between the electrically conductive films sometimes increases.

The present invention further reduces the leakage current flowing between the electrically conductive films and prevents the leakage current from increasing during the continuous operation of the device. The present invention provides an electron-emitting device, an electron source, an image display apparatus, and a television apparatus that can reduce the power consumption and the cost of a drive circuit by decreasing the leakage current.

According to one aspect, the present invention provides an electron-emitting device comprising a silicon oxide body containing halogen and a pair of electrically conductive films formed on the body.

According to another aspect of the present invention, an electron source is provided that comprises a silicon oxide body containing halogen, a plurality of electron-emitting devices, each of which includes a pair of electrically conductive films, arranged on the body, and a wiring connecting the plurality of electron-emitting devices. In one embodiment, this electron source is incorporated into an image display apparatus. As a result, the image display apparatus comprises an electron source comprising a silicon oxide body containing halogen, a plurality of electron-emitting devices, each of which includes a pair of electrically conductive films, arranged on the body, and a wiring connecting the plurality of electron-emitting devices. In addition, the image display appratus also comprises a light-emitting member emitting light in response to being irradiated with electrons emitted from the electron source. In another embodiment, the electron source is incorporated into a television apparatus. As a result, the television apparatus comprises an image display apparatus, a circuit configured to receive an image signal by selecting in image information, and a circuit configured to apply a voltage to the image display apparatus to cause the image display apparatus to display an image on the basis of the image signal. The image display apparatus comprises an electron source and a light-emitting member emitting light in response to being irradiated with electrons emitted from the electron source. The electron source comprises a silicon oxide body containing halogen, a plurality of electron-emitting devices, each of which includes a pair of electrically conductive films, arranged on the body, and a wiring connecting the plurality of electron-emitting devices.

According to still another aspect of the present invention, an electron-emitting device is provided that comprises a first insulator containing halogen, a second insulator on the first insulator, and a pair of electrically conductive films formed on the second insulator. The second insulator contains silicon oxide and has a concave portion between the pair of electrically conductive films. In addition, the concentration of halogen in the first insulator is higher than that in the second insulator.

Still another aspect of the present invention relates to an electron source comprising a first insulator, a second insulator on the first insulator, a plurality of electron-emitting devices, each of which includes a pair of electrically conductive films formed on the second insulator, and a wiring connecting the plurality of electron-emitting devices. The first insulator is made of silicon oxide containing halogen, the second insulator contains silicon oxide and has a concave portion between the pair of electrically conductive films, and the concentration of halogen in the first insulator is higher than that in the second insulator. In one embodiment, this electron source is incorporated into an image display apparatus. As a result, the image display apparatus comprises an electron source and a light-emitting member emitting light in response to being irradiated with electrons emitted from the electron source. The electron source comprises a first insulator, a second insulator on the first insulator, a plurality of electron-emitting devices, each of which includes a pair of electrically conductive films, on the second insulator, and a wiring connecting the plurality of electron-emitting devices. The first insulator is made of silicon oxide containing halogen, the second insulator contains silicon oxide and has a concave portion between the pair of electrically conductive films, and the concentration of halogen in the first insulator is higher than that in the second insulator. In another embodiment, this electron source is incorporated into a television apparatus. The television apparatus comprises an image display apparatus, a circuit configured to receive an image signal by selecting in image information, and a circuit configured to apply a voltage to the image display apparatus to cause the image display apparatus to display an image on the basis of the image signal. The image display apparatus comprises an electron source comprising a plurality of electron-emitting devices. The display apparatus also comprises a wiring connecting the plurality of electron-emitting devices, and a light-emitting member emitting light in response to being irradiated with electrons emitted from the electron source. The electron source also comprises a first insulator and a second insulator on the first insulator. Each of the plurality of electron-emitting devices includes a pair of electrically conductive films, on the second insulator. The first insulator is made of silicon oxide containing halogen, the second insulator contains silicon oxide and has a concave portion between the pair of electrically conductive films, and the concentration of halogen in the first insulator is higher than that in the second insulator.

Further features and advantages of the present invention will become apparent from the following description of exemplary embodiments with reference to the attached drawings.

### BRIEF DESCRIPTION OF THE DRAWINGS

FIG. 1A is a schematic plan view and FIG. 1B is a schematic cross-sectional view of an electron-emitting device according to an embodiment of the present invention.

FIG. 2A is a schematic plan view and FIG. 2B is a schematic cross-sectional view of an electron-emitting device according to another embodiment of the present invention.

FIG. 3 is a schematic cross-sectional view of an electron-emitting device according to still another embodiment of the present invention.

FIGS. 4A through 4E are schematic cross-sectional views illustrating a method for manufacturing an electron-emitting device according to an embodiment of the present invention.

FIG. 5 is a schematic top view of an electron source according to an embodiment of the present invention.

FIG. 6 is a schematic perspective view of an image display apparatus according to an embodiment of the present invention.

FIG. 7 is a schematic block diagram of a television apparatus including an electron-emitting device according to an embodiment of the present invention.

FIGS. 8A and 8B are waveform charts of voltage applied in a process for manufacturing an electron-emitting device according to an embodiment of the present invention.

FIG. 9 is a schematic partially cross-sectional view of an apparatus for measuring the electrical characteristics of an electron-emitting device according to an embodiment of the present invention.

FIG. 10A is a schematic plan view and FIG. 10B is a schematic cross-sectional view of an electron-emitting device according to still another embodiment of the present invention.

### DESCRIPTION OF THE EMBODIMENTS

### First Embodiment

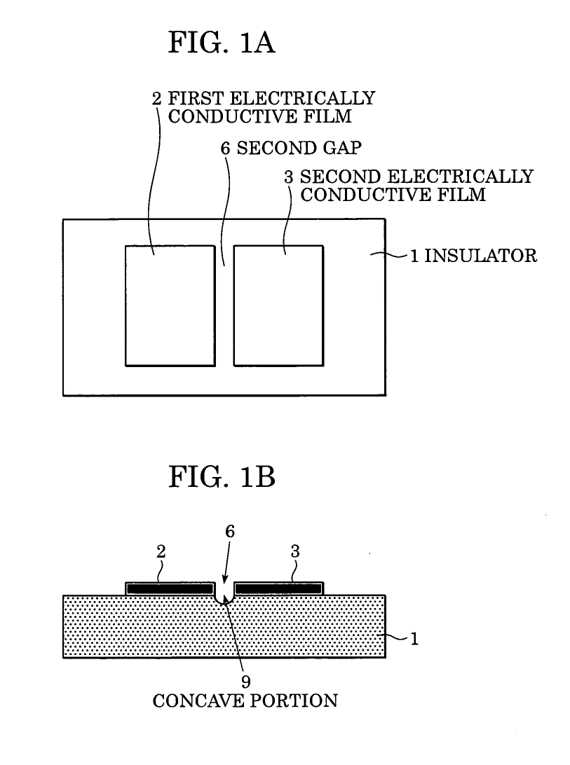

FIGS. 1A and 1B are schematic diagrams of an electron-emitting device according to a basic embodiment of the present invention. FIG. 1A is a plan view and FIG. 1B is a cross-sectional view of the electron-emitting device. The electron-emitting device is composed of a substrate serving as a first insulator 1, a first electrically conductive film 2, a second electrically conductive film 3, a gap 6 between the first electrically conductive film 2 and the second electrically conductive film 3, and a concave portion 9 formed in a surface of the first insulator 1.

In this electron-emitting device, an electric field is formed by the application of a voltage between the first electrically conductive film 2 and the second electrically conductive film 3. Upon the formation of the electric field, electrons are emitted from either the first electrically conductive film 2 or the second electrically conductive film 3. The voltage between the first electrically conductive film 2 and the second electrically conductive film 3 can be from 10 V to 100 V or from 10 V to 30 V.

At least the surface of the first insulator 1 is composed of silicon oxide containing halogen. This can reduce the current flowing in the substrate between the first electrically conductive film 2 and the second electrically conductive film 3. In addition, this can prevent the current from increasing during the continuous operation of the electron-emitting device.

While the reason that the leakage current is reduced and the reason that the increase of the leakage current is suppressed are not clear, it is believed that halogens in the silicon oxide form a bond with a dangling bond of silicon or replace hydrogen of an Si—H bond to prevent the formation of a dangling bond. This may prevent the formation of a leakage-current path in the substrate. Halogens used in the present invention include, but are not limited to, fluorine, chlorine, and bromine. In particular, fluorine is most effective.

Examples of electrically conductive material used in the first electrically conductive film 2 and the second electrically conductive film 3 include a metal, such as Pd, Pt, Ru, Ag, Au, Ti, In, Cu, Cr, Fe, Zn, Sn, Ta, W, or Pb; an oxide, such as PdO, SnO₂, In₂O₃, PbO, or Sb₂O₃; a boride, such as, HfB₂, ZrB₂, LaB₆, CeB₆, YB₄, or GdB₄; a carbide, such as TiC, ZrC, HfC, TaC, SiC, or WC; a nitride, such as TiN, ZrN, or HfN; a semiconductor, such as Si or Ge; and forms of carbon, such as graphite or amorphous carbon. The carbon may be carbon fiber, such as a carbon nanotube, an amorphous carbon fiber, or a graphite nanofiber. These electrically conductive materials may be used alone or in combination.

The distance between the first electrically conductive film 2 and the second electrically conductive film 3 can be in the range of substantially 1 nm to 100 μm, can be preferably in the range of substantially 1 nm to 1 μm, can be more preferably in the range of substantially 1 nm to 10 nm, and can be most preferably in the range of substantially 3 nm to 10 nm. The thicknesses of the first electrically conductive film 2 and the second electrically conductive film 3 can be in the range of substantially 1 nm to 10 μm.

The halogen content in the first insulator 1 can be in the range of substantially 5.0×10¹⁸ to 5.0×10²¹ atoms/cm³, and can be preferably in the range of substantially 1.0×10¹⁹ to 1.0×10²¹ atoms/cm³. In the case that the halogen content is 1.0×10¹⁹ atoms/cm³ or more, the effect of reducing the leakage current is greater. However, in the case that the halogen content is 5.0×10²¹ atoms/cm³ or more, the leakage current may increase significantly. Furthermore, an excessive halogen content may adversely inhibit activation in an activation process described below.

The concave portion 9 can be formed in the surface of the first insulator 1 in the gap 6 between the first electrically conductive film 2 and the second electrically conductive film 3, as shown in FIG. 1B. Since the distance on the surface of the substrate between the first electrically conductive film 2 and the second electrically conductive film 3 is extended by the concave portion 9, the leakage current can be further reduced.

### Second Embodiment

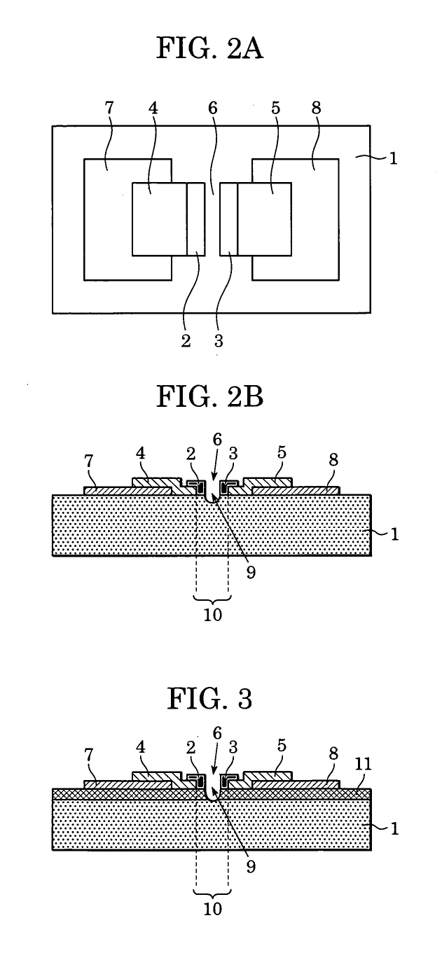

It should be understood that the same reference numerals used in the first and second embodiments refer to the same or similar elements. More generally, when the same reference numerals are used in different drawings relating to different embodiments, they refer to the same or similar element. In an electron-emitting device according to another embodiment of the present invention, as shown in FIG. 2A and FIG. 2B, a third electrically conductive film 4, a fourth electrically conductive film 5, a fifth electrically conductive film 7, and a sixth electrically conductive film 8 can be provided as electrodes to supply a voltage to each of the first electrically conductive film 2 and the second electrically conductive film 3 illustrated in FIGS. 1A and 1B. In this example shown in FIGS. 2A and 2B, an electrode connected to the first electrically conductive film 2 is composed of the third electrically conductive film 4 and the fifth electrically conductive film 7, while an electrode connected to the second electrically conductive film 3 is composed of the fourth electrically conductive film 5 and the sixth electrically conductive film 8. However, each of the electrodes connected to the first electrically conductive film 2 and the second electrically conductive film 3 may be composed of one electrically conductive film or two or more electrically conductive films as described above. FIG. 2A is a plan view of the electron-emitting device according to this embodiment of the present invention. FIG. 2B is a cross-sectional view of the electron-emitting device. The electron-emitting device includes a first gap 10 between the third electrically conductive film 4 and the fourth electrically conductive film 5 and a second gap 6 between the first electrically conductive film 2 and the second electrically conductive film 3. A concave portion 9 can be formed in the first insulator 1 in the second gap 6, as described above.

### Third Embodiment

As shown schematically in FIG. 3, when the electron-emitting device shown in FIGS. 2A and 2B is formed by an activation process described below, the first electrically conductive film 2 and the second electrically conductive film 3 can be disposed on a second insulator 11, which is disposed on the first insulator 1 and contains less halogen than the first insulator 1. In this case, the concave portion 9 can be formed in the surface of the second insulator 11 in the second gap 6.

In the case that the activation process is performed, if the halogen content of the insulator between the first electrically conductive film 2 and the second electrically conductive film 3 is too high, the activation may be suppressed. Thus, the second insulator 11 containing less halogen than the first insulator 1 can be disposed on the first insulator 1. In the case that the second insulator 11 is used, the leakage current flowing in the substrate can be reduced by forming the concave portion 9 in the second insulator 11 in the second gap 6.

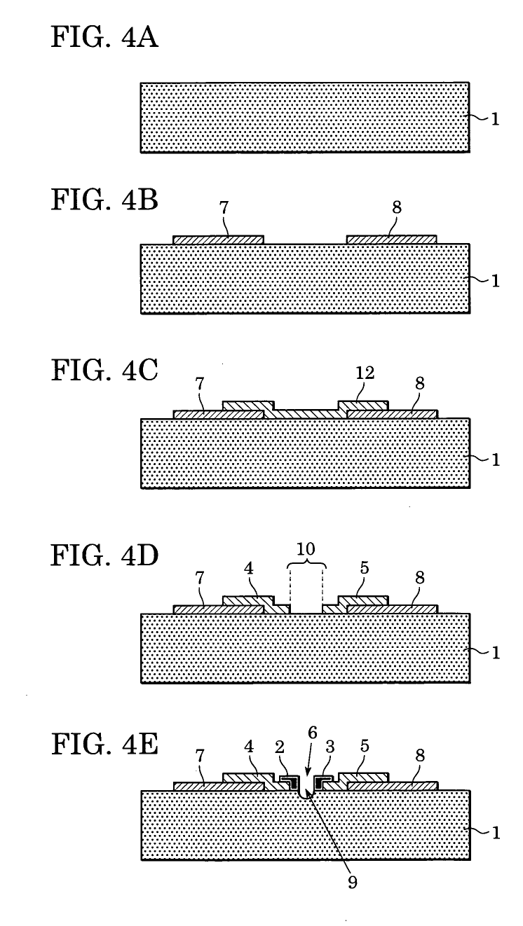

FIGS. 4A through 4E show a method for manufacturing the electron-emitting device according to the embodiment of the present invention shown in FIG. 2. The electron-emitting device may be manufactured according to the processes a through e discussed below.

(Process a)

The first insulator 1 made of silicon oxide containing halogen is prepared (FIG. 4A).

(Process b)

The fifth electrically conductive film 7 and the sixth electrically conductive film 8 are formed on the first insulator 1 (FIG. 4B).

(Process c)

An electrically conductive film 12 is formed to connect the fifth electrically conductive film 7 and the sixth electrically conductive film 8. Then, the first gap 10 is formed in a part of the electrically conductive film 12 to provide the third electrically conductive film 4 and the fourth electrically conductive film 5 (FIGS. 4C and 4D).

(Process d)

The first electrically conductive film 2 and the second electrically conductive film 3 are formed in the first gap 10 and on a part of the third electrically conductive film 4 and on a part of the fourth electrically conductive film 5. Then, the concave portion 9 is formed in the first insulator 1 in the second gap 6 (FIG. 4E).

Each process will be described in detail below.

(Process a)

In the process a, the first insulator 1 made of silicon oxide containing halogen is prepared, for example, by adding halogen to a previously prepared silicon-oxide substrate by an ion implantation method. The silicon-oxide substrate may be made only of silicon oxide. However, a silicon-oxide-based substrate contaminated with impurities is not excluded from the silicon-oxide substrate used in the present invention. Essentially, a substrate containing at least 70% or preferably at least 80% of silicon oxide can be used without causing any problem.

The first insulator 1 may be disposed on a substrate based on Si, quartz glass, soda-lime glass, or ceramic. In this case, a silicon-oxide layer is deposited on the substrate by sputtering, chemical vapor deposition (CVD), coating, or a sol-gel method. Then, a halogen is or halogens are added to the silicon-oxide layer, for example, by an ion implantation method followed by heat treatment, as required.

Alternatively, the silicon oxide containing halogen may be formed by CVD using a raw silicon-oxide gas in combination with a raw material gas containing desired halogen or halogens, or by sputtering using a silicon-oxide gas containing a halogen or halogens as a sputtering gas or a reactant gas. The thickness of the first insulator 1 can be practically in the range of 0.02 μm to 2 μm.

The first insulator 1 may have a halogen content gradient in a direction perpendicular to the surface. The halogen content may increase from the bottom to the top surface of the first insulator 1.

In the case that the electron-emitting device shown in FIG. 3 is to be formed, the second insulator 11 containing silicon oxide with less halogen content than the first insulator 1 may be formed on the first insulator 1 in this process.

The silicon oxide of the second insulator 11 may be formed by the same method as that for forming the first insulator 1 on the substrate. To prevent suppression of the activation process described below, the halogen content in the second insulator 11 can be substantially 1×10¹⁹ atoms/cm³ or less.

The thickness of the second insulator 11 may be equal to or less than the depth of the concave portion 9, which may be formed in the surface of the second insulator 11 in the activation process described below. To reduce the current flowing in the substrate after the activation process, the concave portion 9 may be formed in the second insulator 11 in the second gap 6. The depth of such a concave portion 9 depends on activation or other conditions, and can be practically in the range of substantially 20 nm to 100 nm. The thickness of the second insulator 11 can be in the range of substantially 10 nm to 100 nm. The vertical interval between the deepest point of the concave portion 9 and the second insulator 11 can be substantially 20 nm or less, and can be preferably substantially 10 nm or less.

(Process b)

In the process b, the fifth electrically conductive film 7 and the sixth electrically conductive film 8 are formed on the first insulator 1, for example, by the combination of vacuum evaporation or sputtering and photolithography, or by printing.

Examples of the electrically conductive material used in the fifth electrically conductive film 7 and the sixth electrically conductive film 8 include a metal, such as Ni, Cr, Au, Mo, W, Pt, Ti, Al, Cu, or Pd, and an alloy thereof; a printed conductor composed of a metal oxide, glass, and other materials; and a transparent electric conductor, such as ITO (indium-tin oxide).

The spacing between the fifth electrically conductive film 7 and the sixth electrically conductive film 8 and the thicknesses of the electrically conductive films depend on the application. The spacing between the fifth electrically conductive film 7 and the sixth electrically conductive film 8 can be in the range of substantially 1 μm to 100 μm. The thicknesses of the fifth electrically conductive film 7 and the sixth electrically conductive film 8 may be in the range of substantially 10 nm to 10 μm.

(Process c)

In the process c, the electrically conductive film 12 is formed to connect the fifth electrically conductive film 7 and the sixth electrically conductive film 8. Then, the first gap 10 is formed in a part of the electrically conductive film 12 to provide the third electrically conductive film 4 and the fourth electrically conductive film 5.

The electrically conductive film 12 may be formed by a film-forming process, such as sputtering, vacuum evaporation, or CVD using materials constituting the electrically conductive film 12, or by applying a solution containing the materials constituting the electrically conductive film 12, for example, by dipping, spin coating, slit coating, or an ink-jet method.

The thickness of the electrically conductive film 12 is determined by consideration of the coating performance to the fifth electrically conductive film 7 and the sixth electrically conductive film 8. In the case that a forming process described below is performed after the formation of the electrically conductive film 12, the thickness of the electrically conductive film 12 is determined by consideration of treatment conditions in the forming process. The thickness of the electrically conductive film 12 can be in the range of substantially 0.1 nm to 100 nm or substantially 1 nm to 50 nm.

Examples of the electrically conductive material used in the electrically conductive film 12 include a metal, such as Pd, Pt, Ru, Ag, Au, Ti, In, Cu, Cr, Fe, Zn, Sn, Ta, W, or Pb; an oxide, such as PdO, SnO₂, In₂O₃, PbO, or Sb₂O₃; a boride, such as, HfB₂, ZrB₂, LaB₆, CeB₆, YB₄, or GdB₄; a carbide, such as TiC, ZrC, HfC, TaC, SiC, or WC; a nitride, such as TiN, ZrN, or HfN; and a semiconductor, such as Si or Ge.

In the case that the forming process described below is performed after the formation of the electrically conductive film 12, the shape of the first gap 10 is determined by the sheet resistance of the electrically conductive film 12. Thus, the sheet resistance can be from substantially 1×10³ Ω per square to 1×10⁷ Ω per square to satisfactorily provide the first gap 10.

After the first gap 10 is formed, it is preferable that a voltage applied between the fifth electrically conductive film 7 and the sixth electrically conductive film 8 is sufficiently applied to the first gap 10. Thus, the resistance of the electrically conductive film 12 can be preferably low.

Thus, a metal oxide semiconductor film having a sheet resistance of substantially 1×10³ Ω per square to 1×10⁷ Ω per square can be formed as the electrically conductive film 12. The metal oxide can be reduced after the forming process described below to further decrease the resistance.

To form the first gap 10 in a part of the electrically conductive film 12 to provide the third electrically conductive film 4 and the fourth electrically conductive film 5, for example, the forming process may be used. The forming process may be performed utilizing the Joule heat generated by causing the flowing of an electric current between the fifth electrically conductive film 7 and the sixth electrically conductive film 8. Thus, the first gap 10 can be formed in a part of the electrically conductive film 12 to provide the third electrically conductive film 4 and the fourth electrically conductive film 5.

In the forming process, the voltage that is applied to cause a flow of the electric current between the fifth electrically conductive film 7 and the sixth electrically conductive film 8 can be a pulse voltage. The pulse height of the pulse voltage may be constant or may be increased with time. A method for applying the pulse voltage, as well as the voltage, the pulse width, and the pulse period of the applied pulse voltage are determined depending on the material, the thickness, and the resistance of the electrically conductive film 12. The forming process can be performed in a vacuum or in a gas containing a reducing gas, such as hydrogen.

In addition to the forming process described above, etching or focused ion beam processing may be used to form the first gap 10 in a part of the electrically conductive film 12.

(Process d)

In the process d, the first electrically conductive film 2 and the second electrically conductive film 3 are formed in the first gap 10 and on a part of the third electrically conductive film 4 and on a part of the fourth electrically conductive film 5. Then, the concave portion 9 is formed in the surface of the first insulator 1 in the second gap 6. This process can be performed, for example, by the activation process. The activation process is performed by applying a voltage between the third electrically conductive film 4 and the fourth electrically conductive film 5 (between the fifth electrically conductive film 7 and the sixth electrically conductive film 8), for example, in an atmosphere containing carbon. Such an atmosphere can be generated by introducing a containing-carbon gas, such as an organic gas, for example, after a vacuum vessel is sufficiently evacuated with an oil-free pump.

Examples of the electrically conductive material used in the fifth electrically conductive film 7 and the sixth electrically conductive film 8 include a metal, such as Pd, Pt, Ru, Ag, Au, Ti, In, Cu, Cr, Fe, Zn, Sn, Ta, W, or Pb; an oxide, such as PdO, SnO₂, In₂O₃, PbO, or Sb₂O₃; a boride, such as, HfB₂, ZrB₂, LaB₆, CeB₆, YB₄, or GdB₄; a carbide, such as TiC, ZrC, HfC, TaC, SiC, or WC; a nitride, such as TiN, ZrN, or HfN; and a semiconductor, such as Si or Ge. When the activation process is performed, carbon and/or a carbon compound may be used as a material for the fifth electrically conductive film 7 and the sixth electrically conductive film 8.

Examples of the carbon and/or the carbon compound include graphite and noncrystalline carbon. Graphite includes highly oriented pyrolytic graphite (HOPG), pyrolytic graphite (PG), and glass-like carbon (GC). HOPG has an almost perfect graphitic crystal structure. PG has a crystal grain size of about 20 nm and has a somewhat disordered crystal structure. GC has a crystal grain size of about 2 nm and has a more disturbed crystal structure. The noncrystalline carbon includes amorphous carbon and a mixture of amorphous carbon and microcrystals of the graphite.

The concave portion 9 can be formed in the surface of the first insulator 1 through a sufficiently long activation process. It is believed that the introduced carbon reacts with the silicon oxide constituting the first insulator in the activation process.

In the absence of the activation process, the gap 6 between the first electrically conductive film 2 and the second electrically conductive film 3 and the concave portion 9 in the surface of the first insulator 1 are formed, for example, by etching or focused ion beam processing.

Organic substances used in the activation process include aliphatic hydrocarbons, such as an alkane, an alkene, and an alkyne; aromatic hydrocarbons; alcohols; aldehydes; ketones; amines; and organic acids, such as phenol, carboxylic acid, and sulfonic acid. Specifically, saturated hydrocarbons expressed by CₙH₂ₙ₊₂, such as methane, ethane, and propane; unsaturated hydrocarbons expressed by CₙH₂ₙ, such as ethylene and propylene, benzene, toluene, methanol, ethanol, formaldehyde, acetaldehyde, acetone, methyl ethyl ketone, methylamine, ethylamine, phenol, formic acid, acetic acid, and propionic acid, or a mixture thereof may be used.

The partial pressure of the organic substance may vary depending on the dimensions of the vacuum vessel or the kind of the organic substance used, and can be appropriately determined according to circumstances.

The electron-emitting device according to the present invention can be manufactured by these processes. Furthermore, a stabilizing process can be performed to exhaust the organic substance in the vacuum vessel with an evacuator after the process d. The evacuator can be of oil-free type to prevent oil generated by the evacuator from causing the deterioration of the characteristics of the device. The oil-free evacuator may be a sorption pump or an ion pump.

The partial pressure of the organic component in the vacuum vessel can be in such a range that the further deposition of the carbon or the carbon compound described above can be prevented. The partial pressure of the organic component in the vacuum vessel can be substantially 1.0×10⁻⁶ Pa or less, and can be preferably substantially 1.0×10⁻⁸ Pa or less.

This lowered partial pressure of the organic component in the vacuum vessel can prevent further deposition of the carbon or the carbon compound, and can remove adsorbed H₂O or O₂ on the vacuum vessel or the substrate. This stabilizes a leakage current If flowing between the first electrically conductive film 2 and the second electrically conductive film 3 and an emission current Ie, which is the current of electrons emitted by any of the electrically conductive films not flowing between films 2 and 3. As described later, in a case that an anode is arranged so as to face to the electron-emitting device, the emission current Ie is a component of current flowing between the anode electrode and a ground terminal.

### Fourth Embodiment

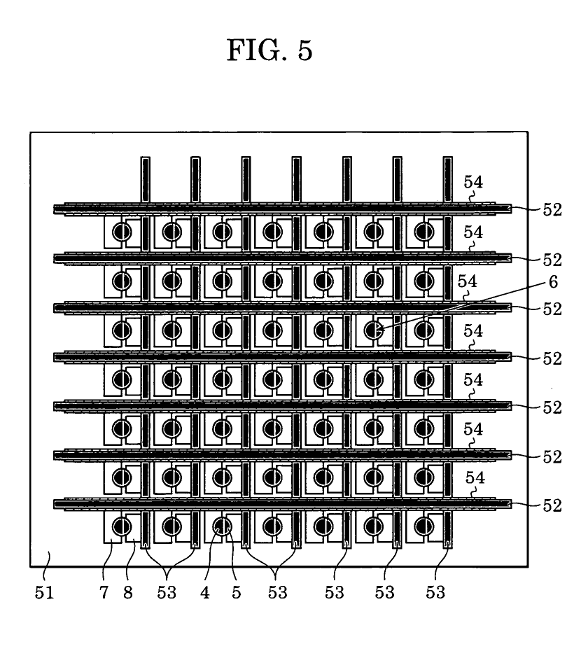

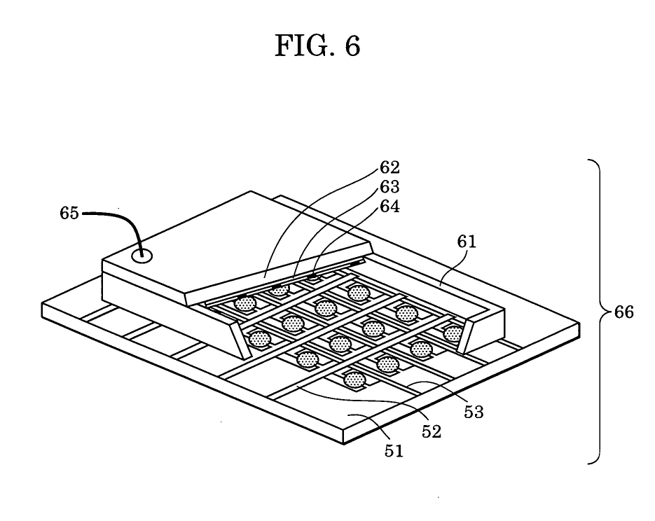

Examples of an electron source and an image display apparatus including a plurality of such electron-emitting devices will be described below with reference to FIG. 5 and FIG. 6.

In FIG. 5, the electron source includes an electron source substrate 51, on which a plurality of electron-emitting devices are arranged in a matrix pattern, and horizontal wires 52 and vertical wires 53, both connected to a pair of electrodes of the electron-emitting devices. In FIG. 5, each electron-emitting device comprises the electron-emitting device shown in FIGS. 2A and 2B, or FIG. 3. In FIG. 6, the image display apparatus includes a plurality of electron-emitting devices, each of which is shown in FIGS. 2A and 2B, or FIG. 3, arranged in a matrix pattern, a frame 61, a glass substrate 62, a fluorescent screen 63 inside the glass substrate 62, a metal back 64 inside the fluorescent screen 63, a high-voltage terminal 65 connected to the metal back 64, and the electron source substrate 51. The electron source substrate 51 and a face plate, which is composed of the glass substrate 62, the fluorescent screen 63, and the metal back 64, are attached to the frame 61, for example, with a low-melting-temperature glass frit.

An envelope 66 is composed of the face plate, the frame 61, and the electron source substrate 51.

In addition, at least one support called a spacer (not shown) can be placed between the face plate and the electron source substrate 51 to provide the envelope 66 with sufficient strength for atmospheric pressure.

Thus, the image display apparatus includes at least the electron-emitting devices arranged on the electron source substrate 51 and the fluorescent screen 63, which emits light upon receiving an electron from the electron-emitting devices.

### Fifth Embodiment

The following is an embodiment of a television apparatus including the image display apparatus.

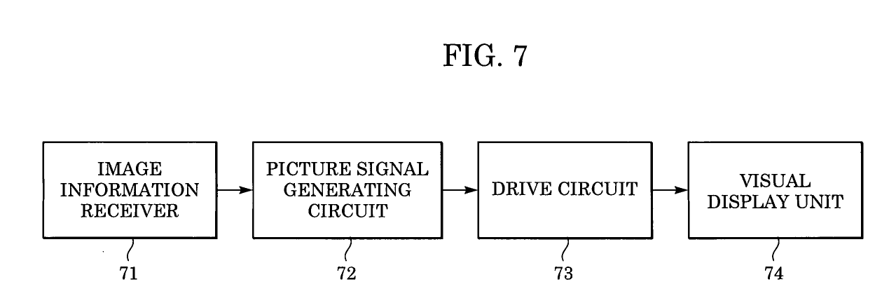

FIG. 7 is a schematic diagram of a television apparatus including the image display apparatus according to the present invention. Thus, for example, the image display apparatus of the television apparatus shown in FIG. 7 can be the image display apparatus shown in FIG. 6. The television apparatus operates as follows. First, an image signal received by an image information receiver 71 by tuning in image information is input to a picture signal generating circuit 72, which in turn generates a picture signal. The image information receiver 71 may be a receiver like a tuner, which can select and receive an image signal in image information via radio broadcasting, cable broadcasting, or the Internet. The image information receiver 71 can be coupled to an acoustic apparatus. The image information receiver 71, the picture signal generating circuit 72, a drive circuit 73, and an image display apparatus 74 manufactured by the method of the present invention can constitute a television set. The picture signal generating circuit 72 generates picture signals corresponding to each pixel of the image display apparatus 74 from the image signal, and sends the picture signals to the drive circuit 73. The drive circuit 73 controls a voltage applied to the image display apparatus 74 on the basis of the input picture signal to display the image on the image display apparatus 74.

The present invention is not limited to the embodiments described above. Each component may be replaced by a substitute or an equivalent that achieves the objective of the present invention.

### EXAMPLES

The present invention will be described in detail with reference to the following examples.

### Example 1

In this example, as the electron-emitting device shown in FIG. 2, six samples having different fluorine contents in the silicon-oxide layer of the insulator were prepared. The method for manufacturing these electron-emitting devices according to this example will be described below.

Process (a)

A silicon-oxide layer having a thickness of 0.4 μm was formed on a cleaned glass substrate by CVD. Then, fluorine ions were implanted over the entire surface of the silicon-oxide layer at an accelerating voltage of 50 keV, except for a sample 4. After heat treatment at 450° C. for 30 minutes, a first insulator 1 was prepared (FIG. 4A). The doses of fluorine ions implanted into the samples were varied between 2.0×10¹⁴ and 2.0×10¹⁷ ions/cm² such that the silicon-oxide layer in each sample had the fluorine content shown in Table 1. The fluorine content in the silicon-oxide layer was determined by secondary ion mass spectrometry (SIMS). After confirming that the transverse distribution of fluorine was substantially uniform, a mean value of the fluorine concentration in the silicon-oxide layer along the direction perpendicular to the surface of the first insulator 1 was determined as the fluorine content. In the sample 4, which contained no implanted fluorine ion, fluorine was not detected in the silicon-oxide layer by an apparatus used to determine the fluorine content in this example. The analysis of the surface of the insulator 1 by electron spectroscopy for chemical analysis (ESCA) showed that fluorine atoms were distributed at the depth of 1 nm to 10 nm of the first insulator 1.

Process (b)

A lift-off pattern of the fifth electrically conductive film 7 and the sixth electrically conductive film 8 was formed with a photoresist. Then, Ti having a thickness of 5 nm and Pt having a thickness of 50 nm were sequentially deposited by vacuum evaporation.

Then, the photoresist pattern was dissolved by an organic solvent to lift off the Pt/Ti deposit film. In this way, the fifth electrically conductive film 7 and the sixth electrically conductive film 8 were formed (FIG. 4B). The gap between the fifth electrically conductive film 7 and the sixth electrically conductive film 8 was 20 μm. The widths of the fifth electrically conductive film 7 and the sixth electrically conductive film 8 were 200 μm.

Process (c)

Then, a palladium complex solution (a palladium acetate monoethanolamine complex dissolved in a mixture of IPA (isopropyl alcohol) and water) was dropped between the fifth electrically conductive film 7 and the sixth electrically conductive film 8 using a bubble jet injector. After calcination at 300° C. for 15 minutes, an electrically conductive film 12 made of palladium oxide was formed (FIG. 4C). The electrically conductive film 12 had an average thickness of 6 nm.

Process (d)

After the substrate was placed in a vacuum vessel, the vacuum vessel was evacuated with a vacuum pump. When the pressure of the vacuum vessel reached 2×10⁻³ Pa, an exhaust valve was closed. Then, a forming process was performed by applying a pulse voltage between the fifth electrically conductive film 7 and the sixth electrically conductive film 8 via external terminals while 2% H₂-containing N₂ gas was introduced into the vacuum vessel.

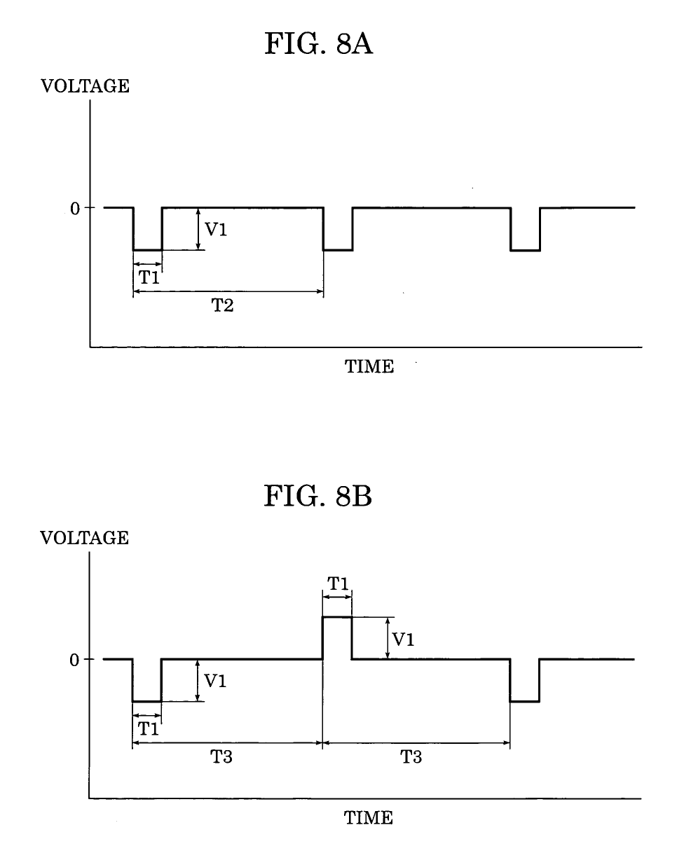

In the forming process, the waveform of the voltage was a pulse shape as shown in FIG. 8A with a peak value V1 of the voltage being 14V, a pulse width T1 being 1 msec, and a pulse period T2 being 50 msec.

During the application of the voltage pulse, a 1 V pulse was inserted to measure the resistance. When the measured resistance reached at least about 1 MΩ, application of the pulse voltage was terminated. In this way, a first gap 10 was formed in the electrically conductive film 12, providing a third electrically conductive film 4 and a fourth electrically conductive film 5 (FIG. 4D).

Then, the third electrically conductive film 4 and the fourth electrically conductive film 5 were reduced by introducing the 2% H₂-containing N₂ gas into the vacuum vessel to a pressure of 2×10⁴ Pa and maintaining the pressure for 30 minutes.

Process (e)

Then, the vacuum vessel was evacuated with the vacuum pump. When the pressure of the vacuum vessel reached 2×10⁻⁵ Pa, tolunitrile was introduced into the vacuum vessel through a slow-leak valve and the vacuum vessel was maintained at 1×10⁻⁴ Pa.

Then, the activation process was performed by applying a pulse voltage between the fifth electrically conductive film 7 and the sixth electrically conductive film 8. A first electrically conductive film 2 and a second electrically conductive film 3, both made of carbon, were deposited. Concurrently, the concave portion 9 was formed in the surface of the first insulator 1 in the second gap 6 between the first electrically conductive film 2 and the second electrically conductive film 3 (FIG. 4E).

The pulse voltage in this case was a bipolar pulse shape as shown in FIG. 8B with a peak value V1 of the voltage being 14V, a pulse width T1 being 1 msec, and a pulse period T3 being 20 msec. The pulse voltage was applied for 60 minutes.

The concave portion 9 formed in the surface of the first insulator 1 in the second gap 6 between the first electrically conductive film 2 and the second electrically conductive film 3 had a depth of 0.06 μm.

The current If at the end of the activation was shown in Table 1.

Process (f)

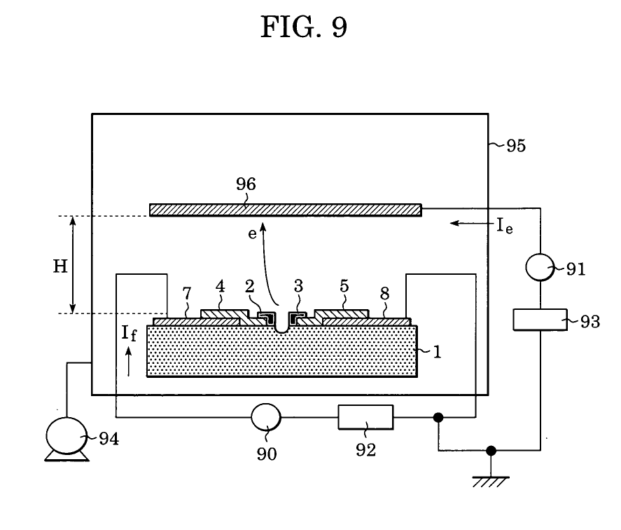

The sample thus prepared was placed in a vacuum vessel 95 as shown in FIG. 9. While the vacuum vessel 95 was evacuated with a vacuum pump 94, the electron-emitting device and the vacuum vessel were heated at 300° C. and 200° C., respectively, for 10 hours. In this way, a stabilizing process was performed.

Then, the electrical characteristics of the sample prepared in this example were measured in the vacuum vessel 95.

In FIG. 9, the vacuum vessel was provided with a first ammeter 90 to measure the current If, a second ammeter 91 to measure the emission current Ie, a power supply 92, a high voltage power supply 93, and an anode 96. In this example, the distance H between the surface of the first electrically conductive film 2 or the second electrically conductive film 3 and the surface of the anode 96 was 2 mm. The electrical characteristics were measured by applying 6 kV to the anode 96.

First, a pulse voltage having a pulse width of 1 msec, a pulse period of 16.7 msec, and a peak value of 19.5 V was applied between the fifth electrically conductive film 7 and the sixth electrically conductive film 8 of the electron-emitting device via the external terminals for 30 seconds. Then, the current If was measured.

Table 1 shows the current If when the voltage between the fifth electrically conductive film 7 and the sixth electrically conductive film 8 was 16 V (corresponding to the voltage of the device when the device is operated to emit electrons). Table 1 also shows the current If (leakage current) when the voltage between the fifth electrically conductive film 7 and the sixth electrically conductive film 8 was 6 V (corresponding to the voltage of the device when the device is not operated).

While the emission current Ie was also measured, when the voltage between the fifth electrically conductive film 7 and the sixth electrically conductive film 8 was 16 V, the ratio Ie/If of the emission current Ie to the current If was almost constant for any sample.

Subsequently, after the pulse voltage having a pulse width of 0.1 msec, a pulse period of 16.7 msec, and a peak value of 16 V was continuously applied to the electron-emitting device for a predetermined time, the current If was measured. Table 1 shows the current If when the voltage between the fifth electrically conductive film 7 and the sixth electrically conductive film 8 was 6 V.

In this example, the current If when the device was operating to emit electrons, the current If when the device was not in operation, and the current If when the device was not in operation after being continuously operated were lower in the samples 1 to 3 than in the samples 4 to 6.

TABLE 1

| | Sample 1 | Sample 2 | Sample 3 | Sample 4 | Sample 5 | Sample 6 |
|---|---|---|---|---|---|---|
| F content in insulator | 1 × 10¹⁹ | 1 × 10²⁰ | 1 × 10²¹ | not | 5 × 10¹⁸ | 5 × 10²¹ |
| (atoms/cm³) | | | | implanted | | |
| Current If at the end | 1.5 | 1.3 | 1.2 | 1.6 | 1.6 | 0.7 |
| of activation (mA) | | | | | | |
| Current If at a voltage | 1.4 | 1.2 | 1.1 | 1.5 | 1.5 | 0.6 |
| of 16 V (mA) | | | | | | |
| Current If at a voltage | 0.03 | 0.02 | 0.01 | 0.10 | 0.08 | 0.04 |
| of 6 V (μA) | | | | | | |
| Current If at a voltage | 0.05 | 0.03 | 0.02 | 0.21 | 0.15 | 0.06 |
| of 6 V after continuous | | | | | | |
| application of | | | | | | |
| pulse voltage (μA) | | | | | | |

### Example 2

In this example, as the electron-emitting device shown in FIG. 3, seven samples having different fluorine contents in the silicon-oxide layers of the first insulator and the second insulator were prepared. The method for manufacturing these electron-emitting devices in this example will be described below.

Process (a)

A silicon-oxide layer having a thickness of 0.4 μm was formed on a cleaned glass substrate by CVD. Then, fluorine ions were implanted over the entire surface of the silicon-oxide layer at an accelerating voltage of 50 keV. After heat treatment at 450° C. for 30 minutes, a first insulator 1 was formed. The doses of fluorine ions implanted into the samples were varied between 6.5×10¹⁴ and 6.5×10¹⁷ ions/cm² such that the silicon-oxide layer in the insulator 1 in each sample had the fluorine content shown in Table 2.

Then, a second insulator 11 was formed by providing a silicon-oxide layer having a thickness of 0.05 μm on the first insulator 1 by CVD. In samples 10, 11, and 13, fluorine ions were implanted over the entire surface of the second insulator 11 at an accelerating voltage of 10 keV, and the samples were heat treated at 450° C. for 30 minutes. The doses of fluorine ions implanted into the samples were varied between 2.5×10¹² and 2.5×10¹⁴ ions/cm² such that the silicon-oxide layer in the second insulator 11 in each sample had the fluorine content shown in Table 2. The measurement of the fluorine content in the silicon-oxide layer and the surface analysis of the silicon-oxide layer was performed as in Example 1.

Process (b) to Process (f)

Then, an electron-emitting device was manufactured as in the process (b) to process (f) in Example 1. The concave portion 9 formed in the surface of the second insulator 11 in the second gap 6 between the first electrically conductive film 2 and the second electrically conductive film 3 had a depth of 0.06 μm. The current If at the end of the activation was shown in Table 2.

The electrical characteristics of the electron-emitting device in this example were measured as in Example 1.

The current If was measured after the application of the pulse voltage as in Example 1.

Table 2 shows the current If when the voltage between the fifth electrically conductive film 7 and the sixth electrically conductive film 8 was 16 V (corresponding to the voltage of the device when the device was operated to emit electrons). Table 2 also shows the current If when the voltage between the fifth electrically conductive film 7 and the sixth electrically conductive film 8 was 6 V (corresponding to the voltage of the device when the device was not operated).

While the emission current Ie was also measured, when the voltage between the fifth electrically conductive film 7 and the sixth electrically conductive film 8 was 16 V, the ratio Ie/If of the emission current Ie to the current If was almost constant for any sample.

Subsequently, after the pulse voltage having a pulse width of 0.1 msec, a pulse period of 16.7 msec, and a peak value of 16 V was continuously applied to the electron-emitting device for a predetermined time, the current If was measured. Table 2 shows the current If when the voltage between the fifth electrically conductive film 7 and the sixth electrically conductive film 8 was 6 V.

In this example, the current If when the device was not in operation, the current If when the device was in operation, and the current If when the device was not in operation after being continuously operated were lower in the samples 7 to 11 than in the samples 12 and 13, while the suppression of the activation was avoided.

TABLE 2

| | Sample 7 | Sample 8 | Sample 9 | Sample 10 | Sample 11 | Sample 12 | Sample 13 |
|---|---|---|---|---|---|---|---|
| F content in second | not | not | not | 5 × 10¹⁷ | 1 × 10¹⁹ | not | 5 × 10¹⁹ |
| insulator (atoms/cm³) | implanted | implanted | implanted | | | implanted | |
| F content in first | 1 × 10¹⁹ | 1 × 10²⁰ | 1 × 10²¹ | 1 × 10²⁰ | 1 × 10²⁰ | 1 × 10¹⁸ | 1 × 10²⁰ |
| insulator (atoms/cm³) | | | | | | | |
| Current If at the | 1.6 | 1.6 | 1.6 | 1.6 | 1.5 | 1.6 | 1.3 |
| end of activation (mA) | | | | | | | |
| Current If at a | 1.5 | 1.5 | 1.5 | 1.5 | 1.4 | 1.5 | 1.2 |
| voltage of 16 V (mA) | | | | | | | |
| Current If at a | 0.03 | 0.02 | 0.01 | 0.02 | 0.02 | 0.09 | 0.02 |
| voltage of 6 V (μA) | | | | | | | |
| Current If at a voltage of | 0.05 | 0.03 | 0.02 | 0.03 | 0.03 | 0.18 | 0.03 |
| 6 V after continuous application | | | | | | | |
| of pulse voltage (μA) | | | | | | | |

### Example 3

In this example, a plurality of the same electron-emitting devices as the sample 8 in Example 2 and an electrical wiring matrix were disposed on a substrate to manufacture an electron source as shown in FIG. 5. The manufacturing method will be described below.

Process (a)

A silicon-oxide layer having a thickness of 0.4 μm was formed on a glass substrate by CVD in the same manner as in Example 2. Then, fluorine ions were implanted over the entire surface of the silicon-oxide layer at an accelerating voltage of 50 keV. After heat treatment at 450° C. for 30 minutes, a first insulator 1 was formed.

Then, a second insulator 51, which is a silicon-oxide layer having a thickness of 0.05 μm, was formed on the first insulator 1 by CVD. In this example, the electron source substrate 51 is composed of the first insulator 1 and the second insulator 11.

Then, a fifth electrically conductive film 7 and a sixth electrically conductive film 8, both made of Pt/Ti, were formed as in Example 2.

Process (b)

Then, a pattern of vertical wirings 53 was formed using a paste material containing Ag as a metal component by screen printing. The paste was applied, was dried at 110° C. for 20 minutes, and was calcined in a heat-treatment apparatus at a peak temperature of 480° C. and a peak holding time of 8 minutes to form the vertical wirings 53.

Process (c)

Then, a pattern of interlayer insulators 54 was formed using a PbO-based paste material by the screen printing. The paste was applied, was dried at 110° C. for 20 minutes, and was calcined in the heat-treatment apparatus at a peak temperature of 480° C. and a peak holding time of 8 minutes to form the interlayer insulators 54.

The interlayer insulators 54 were formed such that a region containing at least an intersecting portion between the horizontal wirings 52 and the vertical wirings 53 was covered, and that a contact hole (not shown) for the electrical connection between the conductive film 7 and the horizontal wirings 52 was provided.

Process (d)

A pattern of the horizontal wirings 52 was formed on an insulator 54 by the screen printing using the same material as that of the vertical wirings 53. The paste was applied, was dried at 110° C. for 20 minutes, and was calcined in the heat-treatment apparatus at a peak temperature of 480° C. and a peak holding time of 8 minutes to form the horizontal wirings 52.

Process (e)

Then, a palladium complex solution (a palladium acetate monoethanolamine complex dissolved in a mixture of IPA and water) was dropped between the fifth electrically conductive film 7 and the sixth electrically conductive film 8 of each electron-emitting device using a bubble jet injector. After calcination at 300° C. for 15 minutes, an electrically conductive film 12 made of palladium oxide was formed. The electrically conductive film 12 had an average thickness of 6 nm.

Process (f)

In this way, the electron-emitting devices, the electrical wirings, and interlayer insulators were formed on the substrate. The substrate was placed in a vacuum vessel. The vacuum vessel was evacuated with a vacuum pump. When the pressure of the vacuum vessel reached 2×10⁻³ Pa, an exhaust valve was closed. Then, the forming of the electron-emitting devices was performed by applying a pulse voltage between the horizontal wirings 52 and the vertical wirings 53 via external terminals while 2% H₂-containing N₂ gas was introduced into the vacuum vessel. The voltage during the forming operation had the same waveform as in Example 1. The vertical wirings 53 were together connected to a ground terminal. The voltage was applied sequentially to each of the horizontal wirings 52.

During the application of the voltage pulse, a 1 V pulse was inserted into the pulse voltage waveform to measure the resistance. When the measured resistance per device reached at least 1 MΩ, the voltage pulse was terminated. In this way, a first gap 10 was formed in the electrically conductive film 12 of each electron-emitting device, providing a third electrically conductive film 4 and a fourth electrically conductive film 5.

Then, the third electrically conductive film 4 and the fourth electrically conductive film 5 were reduced by introducing the 2% H₂-containing N₂ gas into the vacuum vessel to a pressure of 2×10⁴ Pa and maintaining the pressure for 30 minutes.

Process (g)

Then, the vacuum vessel was evacuated with the vacuum pump. When the pressure of the vacuum vessel reached 2×10⁻⁵ Pa, tolunitrile was introduced into the vacuum vessel through a slow-leak valve and the vacuum vessel was maintained at 1×10⁻⁴ Pa.

Then, the vertical wirings 53 were together connected to a ground terminal. The pulse voltage was applied sequentially to each of the horizontal wirings 52 for activation. The waveform and the application period of the voltage in the activation process were the same as in Example 1.

Process (h)

The electron source substrate was placed in the vacuum vessel again. While the vacuum vessel was evacuated, the electron source substrate and the vacuum vessel were heated at 300° C. and 200° C., respectively, for 10 hours to perform a stabilizing process.

Then, the electrical characteristics of the electron source thus prepared were measured in the vacuum vessel.

In FIG. 5, the vertical wirings 53 can be denoted by Dx1, Dx2, . . . Dxn, where n is a positive integer representing the number of vertical wirings, while the horizontal wirings 52 can be denoted by Dy1, Dy2, . . . Dyn, wherein m is a positive integer representing the number of horizontal wirings. In this process, first, one of the vertical wirings 53 (Dx1) was selected. A pulse voltage of +6 V having a pulse width of 1 msec and a pulse period of 16.6 msec was applied to the Dx 1 wiring. In synchronism with this pulse voltage, another pulse voltage of −13.5 V having a pulse width of 1 msec and a pulse period of 16.6 msec was sequentially applied to each of the horizontal wirings 52 (Dy1 to Dym) for 30 seconds each. The same procedure was repeated for the other vertical wirings (Dx2 to Dxn) to apply the pulse voltage of 19.5 V to all of the electron-emitting devices. Unselected electrical wirings were connected to the ground terminal.

Then, in the same way, one of the vertical wirings 53 (Dx1) was selected and a pulse voltage of +6 V having a pulse width of 0.1 msec and a pulse period of 16.6 msec was applied to the Dx 1 wiring. In synchronism with this pulse voltage, another pulse voltage of −10 V having a pulse width of 0.1 msec and a pulse period of 16.6 msec was sequentially applied to each of the horizontal wirings 52 (Dy1 to Dym) for 30 seconds each. The same procedure was repeated for the other vertical wirings (Dx2 to Dxn) to apply the pulse voltage of 16 V to all of the electron-emitting devices, driving the electron-emitting devices. The current If flowing in each of the electron-emitting devices in operation was measured.

Then, all the horizontal wirings 52 were connected to the ground terminal. One of the vertical wirings 53 (Dx1) was selected and a pulse voltage of +6 V having a pulse width of 0.1 msec and a pulse period of 16.6 msec was applied to the Dx 1 wiring. The current If flowing in the electron-emitting device connected to the selected vertical wiring (Dx1) was measured. Then, the same procedure was repeated for the other vertical wirings (Dx2 to Dxn), and the current If flowing in each of the vertical wirings was measured.

Then, a pulse voltage of +6 V having a pulse width of 0.1 msec and a pulse period of 16.6 msec was sequentially applied to each of the vertical wirings 53. In synchronism with this pulse voltage, another pulse voltage of −10 V having a pulse width of 0.1 msec and a pulse period of 16.6 msec was sequentially applied to each of the horizontal wirings 52 to continuously drive all of the electron-emitting devices for a predetermined time. Then, in the same way as described above, the current If flowing in each of the vertical wirings was measured.

The results showed that the current If per device during the operation of the device was 1.5 mA, the current If per device during the time corresponding to when the device was not operated was 0.02 μA, and the current If per device during the time corresponding to when the device was not operated after the continuous operation was 0.03 μA (all of these were mean values), indicating the similar characteristics as the sample 8 in Example 2.

### Example 4

In this example, an image display apparatus shown in FIG. 6 was manufactured using an electron source manufactured according to the present invention.

An electron source substrate 51 after the activation process was prepared as in Example 3.

Then, a face plate was attached on a frame 61 at a distance of 2 mm from the electron source substrate 51 in a vacuum to form an envelope 66. A spacer (not shown) was disposed between the electron source substrate 51 and the face plate to withstand exposure to atmospheric pressure. A getter (not shown) was placed in the envelope 66 to maintain the vessel at a high vacuum. Indium was used to attach the electron source substrate 51, the frame 61, and the face plate.

As in Example 3, a pulse voltage was applied to the image display apparatus thus manufactured, and the current If was measured. The results showed that the current If per device during the operation of the device was 1.5 mA and the current If when the device was not operated was 0.02 μA (both were mean values), indicating the similar characteristics as in Example 3.

Then, the electron-emitting devices were operated while an information signal was applied to the vertical wirings 53 and a scanning signal was applied to the horizontal wirings 52. The information signal was a pulse voltage of +6 V. The scanning signal was a pulse voltage of −10 V. A voltage of 6 kV was applied to the metal back 64 via the high-voltage terminal 65. When emission electrons were directed to the fluorescent screen 63 for excitation and luminescence, a bright image was displayed.

After the continuous operation of the electron-emitting devices as in Example 3, the current If was measured. The mean value of the current If per device when the device was not operated was 0.03 μA, which was the same as that in Example 3.

Thus, in the image display apparatus in this example, the current If flowing in an unselected device was reduced. This also reduced the power consumption.

### Example 5

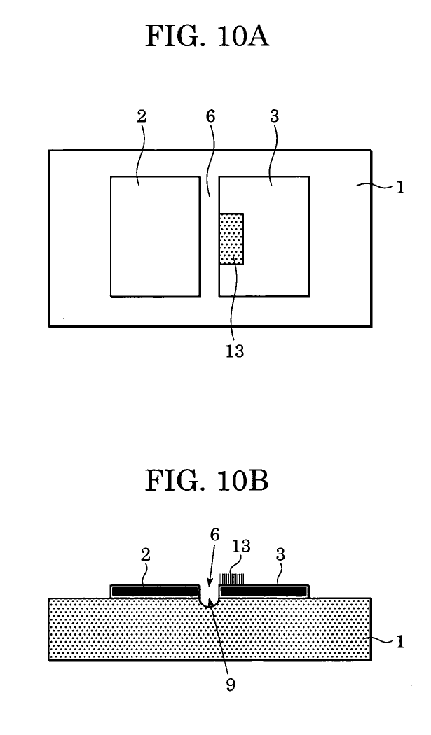

In this example, as shown in FIG. 10, an electron-emitting device containing carbon fibers on a second electrically conductive film 3 was manufactured. The method for manufacturing the electron-emitting device in this example is described below.

Process (a)

A silicon-oxide layer containing fluorine was formed by the same method as in the process (a) of Example 1.

Process (b)

A lift-off pattern of the first electrically conductive film 2 and the second electrically conductive film 3 was formed with a photoresist. Then, Ti having a thickness of 5 nm and Pt having a thickness of 50 nm were sequentially deposited by vacuum evaporation. Then, the photoresist pattern was dissolved by an organic solvent to lift off the Pt/Ti deposit film. The first electrically conductive film 2 and the second electrically conductive film 3 were formed. The gap between the first electrically conductive film 2 and the second electrically conductive film 3 was 5 μm. The widths of the first electrically conductive film 2 and the second electrically conductive film 3 were 200 μm.

Process (c)

A resist was applied to the first electrically conductive film 2, the second electrically conductive film 3, and the first insulator 1 outside the gap between the first electrically conductive film 2 and the second electrically conductive film 3. A concave portion 9 was formed by etching the surface of the first insulator 1 between the first electrically conductive film 2 and the second electrically conductive film 3. Then, the resist was removed. The depth of the concave portion 9 was 0.06 μm.

Process (d)

In a photolithography process, a resist pattern was formed with a negative photoresist used in the subsequent lift-off.

A particulate Pd—Co alloy catalyst was formed on the resist pattern by sputtering. The contents of Pd and Co in the catalyst particle were both about 50 atm %.

The catalyst particles on the resist were lifted off together with the resist using a resist stripper to form a pattern of the catalyst particles on the desired area.

Process (e)

After heat treatment in a stream of ethylene, a member 13 consisting of a plurality of carbon fibers was formed. Observation by a scanning electron microscope revealed that many carbon fibers were formed. These carbon fibers were graphite nanofibers having laminated graphenes so that each of the graphenes crosses the axial direction of the fiber.

The electrical characteristics of the electron-emitting device in this example were measured as in Example 1.

In this example, a voltage was applied between the first electrically conductive film 2 and the second electrically conductive film 3, instead of between the fifth electrically conductive film 7 and the sixth electrically conductive film 8 in Example 1. The electric potential of the first electrically conductive film 2 was set to be higher than that of the second electrically conductive film 3. The voltage applied was the same as in Example 1.

The results showed that the current If during the operation of the device was reduced, as in Example 1. A reduction in the current If when the device was not operated after the continuous operation was also observed.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-191634 filed Jun. 29, 2004, which is hereby incorporated by reference herein.

1. An electron-emitting device comprising:
a silicon oxide body containing halogen; and
a pair of electrically conductive films formed on said body.

2. The electron-emitting device according to claim 1, wherein said body has a concave portion between said pair of electrically conductive films.

3. The electron-emitting device according to claim 1, wherein the halogen is fluorine.

4. The electron-emitting device according to claim 1, wherein said body contains substantially 1.0×10¹⁹ to 1.0×10²¹ atoms/cm³ of the halogen.

5. An electron source comprising:
a silicon oxide body containing halogen;
a plurality of electron-emitting devices, each of which includes a pair of electrically conductive films, arranged on said body; and
a wiring connecting said plurality of electron-emitting devices.

6. An image display apparatus comprising:
an electron source comprising:
a silicon oxide body containing halogen;
a plurality of electron-emitting devices, each of which includes a pair of electrically conductive films, arranged on said body; and
a wiring connecting said plurality of electron-emitting devices; and
a light-emitting member emitting light in response to being irradiated with electrons emitted from said electron source.

7. A television apparatus comprising:
an image display apparatus comprising:
an electron source comprising:
a silicon oxide body containing halogen;
a plurality of electron-emitting devices, each of which includes a pair of electrically conductive films, arranged on said body; and
a wiring connecting said plurality of electron-emitting devices; and
a light-emitting member emitting light in response to being irradiated with electrons emitted from said electron source;
a circuit configured to receive an image signal by selecting in image information; and
a circuit configured to apply a voltage to said image display apparatus to cause said image display apparatus to display an image on the basis of the image signal.

8. An electron-emitting device comprising:
a first insulator containing halogen;
a second insulator on said first insulator; and
a pair of electrically conductive films formed on said second insulator,
wherein said second insulator contains silicon oxide and has a concave portion between said pair of electrically conductive films; and
wherein the concentration of halogen in said first insulator is higher than that in said second insulator.

9. The electron-emitting device according to claim 8, wherein the halogen is fluorine.

10. The electron-emitting device according to claim 8, wherein said first insulator contains substantially 1.0×10¹⁹ to 1.0×10²¹ atoms/cm³ of the halogen.

11. The electron-emitting device according to claim 8, wherein said second insulator contains substantially 1.0×10¹⁹ atoms/cm³ or less of the halogen.

12. An electron source comprising:
a first insulator;
a second insulator on said first insulator;
a plurality of electron-emitting devices, each of which includes a pair of electrically conductive films, on said second insulator; and
a wiring connecting said plurality of electron-emitting devices,
wherein said first insulator is made of silicon oxide containing halogen,
wherein said second insulator contains silicon oxide and has a concave portion between said pair of electrically conductive films, and
wherein the concentration of halogen in said first insulator is higher than that in said second insulator.

13. An image display apparatus comprising:
an electron source comprising:
a first insulator;
a second insulator on said first insulator;
a plurality of electron-emitting devices, each of which includes a pair of electrically conductive films, on said second insulator; and
a wiring connecting said plurality of electron-emitting devices,
wherein said first insulator is made of silicon oxide containing halogen,
wherein said second insulator contains silicon oxide and has a concave portion between said pair of electrically conductive films, and
wherein the concentration of halogen in said first insulator is higher than that in said second insulator; and
a light-emitting member emitting light in response to being irradiated with electrons emitted from said electron source.

14. A television apparatus comprising:
an image display apparatus comprising:
an electron source comprising:
a first insulator;
a second insulator on said first insulator;
a plurality of electron-emitting devices, each of which includes a pair of electrically conductive films, on said second insulator; and
a wiring connecting said plurality of electron-emitting devices,
wherein said first insulator is made of silicon oxide containing halogen,
wherein said second insulator contains silicon oxide and has a concave portion between said pair of electrically conductive films, and
wherein the concentration of halogen in said first insulator is higher than that in said second insulator; and
a light-emitting member emitting light in response to being irradiated with electrons emitted from said electron source;
a circuit configured to receive an image signal by selecting in image information; and
a circuit configured to apply a voltage to said image display apparatus to cause said image display apparatus to display an image on the basis of the image signal.
